(19) United States
(12) Patent Application Publication
(10) Pub. No.: US 2009/0148820 A1
(43) Pub. Date: Jun. 11, 2009

(54) TRAINING DEVICE

(76) Inventor: Stephan Gerster, Bad Breisig (DE)

Correspondence Address: DARBY & DARBY P.C., P.O. BOX 770, Church Street Station, New York, NY, 10008-0770, US

(21) Appl. No.: 12/172,972

(22) Filed: Jul. 14, 2008

(30) Foreign Application Priority Data
Jan. 12, 2006 (DE) 10 2006 001 813.3

(51) Int. Cl. G09B 19/00

(52) U.S. Cl. 434/258

(57) ABSTRACT

The invention concerns a training device for examining and/or for training motor coordination ability and/or motor, especially support motor control processes of a human or an animal.

### CROSS-REFERENCE TO RELATED APPLICATION

This application claims the benefit of the priority filing date of PCT/DE2007/000058 referenced in WIPO Publication WO 2007/079735 A2. The earliest priority date claimed is Jan. 12, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention concerns a training device for examining and/or for training motor coordination ability and/or motor, especially support motor control processes of a human or an animal.

Training devices of this kind are known in practice. However, they are not suitable for automatic reproducible operation. Therefore, the basic problem of the present invention is to specify a training device of the kind described above that is suitable to ensure training conditions that are reproducible in the context of an automatic operation.

### SUMMARY

The above problem is solved by the features of patent claim 1, referring to a training device comprising a spring-mounted training plate.

In a preferred embodiment, the training plate is configured as a tread plate, and at least one spring element is provided to carry the training plate. The spring element comprises springs and/or elastic balls and/or elastic rubber elements and/or elastic foam elements.

Furthermore, in another preferred embodiment, at least one non-spring-Like bearing element is provided, which carries the training plate.

The training plate is best carried by both spring-like and non-spring-like elements. Furthermore, the training plate is arranged so that it can be deflected and/or moved and/or swiveled and/or tilted from a neutral position against the force of the at least one spring element.

Furthermore, the training device is configured such that the force receiving element comprises a tread plate, on which a person can stand. The tread plate can be configured triangular, square, polygonal, or round or oval. A designated standing surface is marked on the tread plate.

At least one measurement sensor measures forces acting on the force receiving element at regular intervals of time, and the intervals of time can each be less than one millisecond. The time intervals can lie in the range of 0.02 seconds and one millisecond, especially in the range of 0.02 seconds and 0.005 seconds, preferably in the range of 0.01 and 0.04 seconds. The time intervals advantageously amount to 0.02 seconds or 0.01 seconds or 0.04 seconds each.

Furthermore, an evaluation device is provided that computes a sum from the measurement signals of at least two measurement sensors. The evaluation device computes a sum each time from the measurement signals of at least two measurement sensors at regular time intervals. It is also conceivable for the evaluation device to compute the center of gravity of the acting force from the measurement signals of at least two measurement sensors. Furthermore, it is conceivable for the evaluation device to compute, each time, the center of gravity of the acting force at regular time intervals from the measurement signals of at least two measurement sensors. It is also conceivable for the evaluation device to determine the location of the center of gravity as a function of time.

In a further preferred embodiment, the evaluation device determines the time derivative of the measurement signals of at least one measurement sensor and/or the calculated sum. The evaluation device can also determine the time average of the measurement signals of at least one measurement sensor and/or the computed sums. The same holds for the Fourier transform of the measurement signals of at least one measurement sensor and/or the computed sums.

Furthermore, the evaluation device could determine a power value, especially the power value of the power applied by the person being examined to stabilize a position of equilibrium. Furthermore, the evaluation device could determine or compute the work performed against the force of the resetting device. Specifically, the evaluation device could determine the work performed each time within a time interval against the force of the resetting device.

### DESCRIPTION

The above problem is solved by the features of patent claim 1, referring to a training device comprising a spring-mounted training plate.

In a preferred embodiment, the training plate is configured as a tread plate, and at least one spring element is provided to carry the training plate. The spring element comprises springs and/or elastic balls and/or elastic rubber elements and/or elastic foam elements.

Furthermore, in another preferred embodiment, at least one non-spring-like bearing element is provided, which carries the training plate.

The training plate is best carried by both spring-like and non-spring-like elements. Furthermore, the training plate is arranged so that it can be deflected and/or moved and/or swiveled and/or tilted from a neutral position against the force of the at least one spring element.

The training plate can have any desired shape. In a preferred embodiment, it is triangular, square or polygonal, or round or oval in configuration. A designated standing surface is marked on the training plate.

At least one measurement sensor measures the forces acting on the force receiving element as a function of time, preferably at regular time intervals. The time intervals should be shorter than one millisecond. Specifically, the time intervals can lie in the range of 0.02 seconds and one millisecond, especially in the range of 0.02 seconds and 0.005 seconds, especially in the range of 0.01 and 0.04 seconds. It is conceivable for the time intervals to amount to 0.02 seconds or 0.01 seconds or 0.04 seconds each.

In a further preferred embodiment, an evaluation device is provided that receives the measurement signals of at least one measurement sensor. The evaluation device computes a sum from the measurement signals of at least two measurement sensors. In the best mode, it computes a sum each time from the measurement signals of at least two measurement sensors. Specifically, the evaluation device could compute the center of gravity of the acting force from the measurement signals of at least two measurement sensors. In the best mode, the evaluation device computes, each time, the center of gravity of the acting force at regular intervals from the measurement signals of at least two measurement sensors. Furthermore, it is conceivable for the evaluation device to determine the location of the center of gravity as a function of time. The same holds for the time derivative of the measurement signals of at least one measurement sensor and/or the calculated sum.

Furthermore, it is conceivable for the evaluation device to determine the time average of the measurement signals of at least one measurement sensor and/or the computed sum. The evaluation device can also determine the Fourier transform of the measurement signals of at least one measurement sensor and/or the computed sums. In a preferred embodiment, the evaluation device determines a power value of the power applied by the person being examined to stabilize a position of equilibrium.

In a preferred embodiment, the evaluation device determines a power value from the time average of the measurement signal of at least one measurement sensor and/or from the time average of the computed sums and/or from the time derivative of the measurement values of at least one measurement sensor and/or from the time derivative of the computed sums and/or from the Fourier transform of the measurement signals of at least one measurement sensor and/or from the Fourier transform of the computed sums.

The evaluation device determines the work performed against the force of the resetting device. This can occur—preferably periodically—within a time interval.

The training device in the best mode includes an accessory for a measurement device, which is used to examine the motor coordination ability and/or to examine motor control processes, especially postural motor control processes, of a human or animal. Accordingly, the measurement device comprises a force receiving element and at least one measurement sensor, that measures the forces acting on the force receiving element as a function of time. The training plate has the same shape as the force receiving element of the measurement device.

Furthermore, it is advantageous for the force receiving element to be arranged stationary with respect to the rest of the measurement device—apart from the deflection needed to measure the forces. Moreover, the force receiving element is held in a neutral position by a resetting device. The force receiving element is arranged so that it can be deflected and/or moved and/or swiveled and/or tilted from the neutral position against the force of the resetting device. The resetting device contains a spring device, and the resetting device can be part of the measurement sensor. The resetting device can work electromagnetically.

At least one measurement sensor should have a dynamometric cell, especially a weighing cell. Furthermore, the measurement sensor can have a tilt sensor or inclination sensor. Likewise, the measurement sensor can include a strain gage strip. The measurement sensor can work in various ways, preferably inductively and/or capacitively.

In further preferred embodiment, at least one sensor contains at least one device for measuring the change in an electric and/or magnetic field. Moreover, the measurement sensor can have an electrical measurement coil and/or an antenna.

In a further preferred embodiment, the measurement sensor can work optically, and at least one light source is assigned to the measurement sensor. The light source can be a laser, especially a semiconductor laser, or a light diode.

The measurement sensor furthermore comprises a light detector, and the light detector produces an electrical signal depending on the point of impact of the light radiation. The light detector can be a PSD (position sensitive device).

The measurement device furthermore comprises one or more measurement sensors.

The force receiving element can be mounted at one point, two points, or multiple points. A bearing ball could be provided at least at one bearing point, and it is conceivable to arrange one measurement sensor on one bearing point or to arrange measurement sensors at all bearing points.

The training device comprises a computer, preferably a PC. It is best for a display or monitor screen to be present, serving to indicate the measurement values and/or the computed values. In a preferred embodiment, the display device shows the measurement values and/or the computed values in graphically prepared representation. It is also conceivable for the display device to show the time change in the location of the center of gravity in an x-y plot. The time change in the location of the center of gravity can be displayed by means of a diagram with different colored regions.

Finally, an interface is provided to relay measurement values and/or computed values to a PC and/or to a network and/or to a data storage device.

1. A training device for examining and/or for training motor coordination ability and/or motor, especially support motor, control processes of a human or an animal, having a spring-mounted training plate.

2-83. (canceled)
